(19) United States
(12) Patent Application Publication
(10) Pub. No.: US 2012/0074025 A1
(43) Pub. Date: Mar. 29, 2012

(54) INSECT REPELLING DEVICE USING MACLURA POMIFERA

(76) Inventor: Carol De Mull, Kentwood, MI (US)

(21) Appl. No.: 12/890,788

(22) Filed: Sep. 27, 2010

(51) Int. Cl. B65D 85/00; A01N 65/08

(52) U.S. Cl. 206/524.1; 424/769

(57) ABSTRACT

An insect repelling device comprising a container and a mixture. The container comprises a bottom wall, a side wall, and optionally a removable lid adapted to receive the side wall. The mixture can comprise paraffin wax and an insect repelling ingredient extracted from Maclura pomifera. The container contains the mixture. The insect repelling ingredient extracted from Maclura pomifera can comprise elemol. The insect repelling ingredient extracted from Maclura pomifera can comprise a stilbene. The stilbene can comprise 2′, 3, 4′, 5-tetrahydroxy-stilbene. The insect repelling ingredient can comprise Maclura pomifera, such as the fruit of Maclura pomifera, the essential oil extract of Maclura pomifera, or the wood of Maclura pomifera. The mixture can comprise a wax, such as of bayberry wax, bees wax, Chinese wax, Japan wax, ozokerite, or rice bran wax. A method of repelling insects using an embodiment of the insect repelling device.

### BACKGROUND

The present invention generally relates to a device using matter from Maclura pomifera to repel insects. Maclura pomifera is the Latin botanical name for the plant commonly known as the Osage orange tree. Insects are generally unwanted in and around buildings, especially dwellings.

### SUMMARY OF THE INVENTION

Described herein are several embodiments of an insect repelling device. A method of repelling insects using an embodiment of the device is additionally described herein.

More specifically, described herein is an insect repelling device comprising a container and a mixture. The container contains the mixture.

The container can comprise a bottom wall and a side wall. The container can further comprise a removable lid adapted to receive the side wall.

The mixture comprises Maclura pomifera. The Maclura pomifera can comprise or consist essentially of the fruit of Maclura pomifera. The Maclura pomifera can comprise or consist essentially of the essential oil extract of Maclura pomifera. The Maclura pomifera can comprise or consist essentially of the wood of Maclura pomifera.

The mixture can comprise or consist essentially of an insect repelling ingredient extracted from Maclura pomifera. The insect repelling ingredient extracted from Maclura pomifera can be elemol. The insect repelling ingredient extracted from Maclura pomifera can be a stilbene. The stilbene can be 2′, 3, 4′, 5-tetrahydroxystilbene.

The mixture can further comprise wax. The wax can be one or more of the group of waxes consisting of bayberry wax, bees wax, Chinese wax, Japan wax, ozokerite, rice bran wax, and paraffin wax. The wax can be just or primarily paraffin wax.

Additionally described herein is a method of repelling insects in or around an area of a building, such as a dwelling, comprising the steps of: (a) noticing an area of a building where insects are present; (b) presenting an embodiment of the insect repelling device described herein; and (c) placing the insect repelling device in the area of the building.

### BRIEF DESCRIPTION OF THE SEVERAL VIEWS OF THE DRAWINGS

FIG. 1 depicts a perspective view of one embodiment of insect repelling device 10 showing the removable lid 20 and the container 12 with mixture 14; and

FIG. 2 depicts a perspective view of one embodiment of insect repelling device 10 placed in an area of a building 22 where insects 24 are present but undesired.

### DETAILED DESCRIPTION OF THE PREFERRED EMBODIMENTS

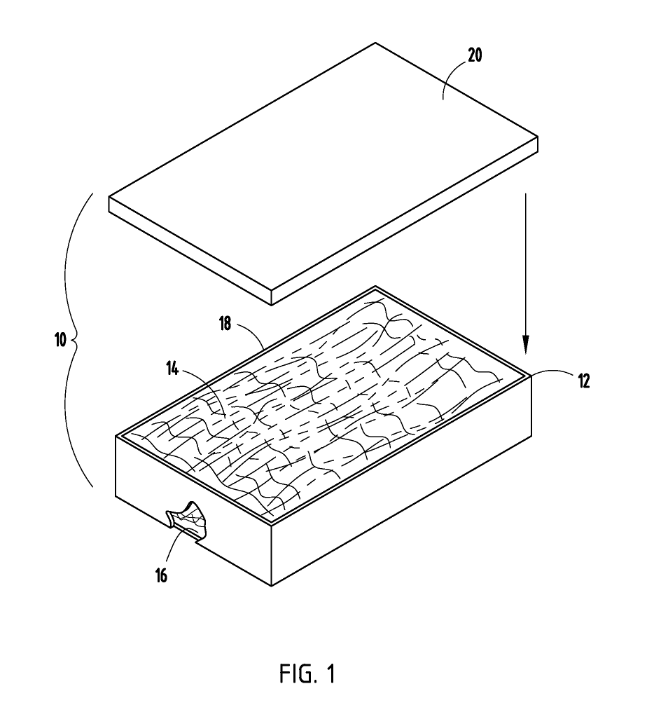

For purposes of description herein, the terms “upper,” “lower,” “right,” “left,” “rear,” “front,” “vertical,” “horizontal,” “height,” “length,” “width,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification are exemplary embodiments of the inventive concepts defined in the appended claims. Hence, specific dimensions and other physical characteristics relating to the embodiments disclosed herein are not to be considered as limiting, unless the claims expressly state otherwise.

In a first embodiment of an insect repelling device 10 (FIG. 1), the insect repelling device 10 comprises a container 12 and a mixture 14. The container 12 contains the mixture 14. The insects to be repelled can include spiders and bed bugs (insects from the family Cimicidae). The mixture 14 can kill insects as well as repel them.

The container 12 can comprise a bottom wall 16 and a side wall 18. The container 12 can further comprise a removable lid 20 adapted to receive the side wall 18. The container 12 can resemble an Altoids® breath mint container. The container 12 can be made from tin, plastic, or any other material capable of holding mixture 14. The container 12 can measure 5″×7″ in width and length and be any height. However, the container 12 can have any dimensions. The removable lid 20 can fit over the side walls 18 and be freely removable. Alternatively, the removable lid 20 can be hinged (not shown) to the side wall 18.

The mixture 14 comprises Maclura pomifera. Maclura pomifera is the Latin botanical name for the plant commonly referred to as the Osage orange tree. Maclura pomifera bears a fruit, which takes the size of a large orange. Maclura pomifera has a wood portion that is very strong and elastic. The greater the concentration of Maclura pomifera that is present in the mixture 14, the more likely the insect repelling device 10 will kill rather than just repel insects.

The Maclura pomifera can comprise or consist essentially of the fruit of Maclura pomifera. In other words, the mixture 14 can comprise or consist essentially of the fruit of Maclura pomifera. For example, a whole fruit of Maclura pomifera can be chopped, liquefied, puréed, or otherwise broken down and made part of mixture 14. The greater the concentration of fruit of Maclura pomifera that is present in the mixture 14, the more likely the insect repelling device 10 will kill rather than just repel insects.

The Maclura pomifera can comprise or consist essentially of the essential oil extract of Maclura pomifera. In other words, the mixture 14 can comprise or consist essentially of the essential oil extract of Maclura pomifera. The essential oil can be extracted from Maclura pomifera through steam distillation of the whole fruit. One method of extraction is set forth in the article Peterson, C. K.; Zhu J.; Coats, J. R. J. Essent. Oil Res. 2002, 14, 233-236, and that article is incorporated herein by reference in its entirety. The essential oil can then be added and made part of mixture 14. The greater the concentration of essential oil extract of Maclura pomifera that is present in the mixture 14, the more likely the insect repelling device 10 will kill rather than just repel insects.

The Maclura pomifera can comprise or consist essentially of the wood of Maclura pomifera. For example, the wood of Maclura pomifera can be dried and made into a powder. The powdered wood can then be added and made part of mixture 14. The greater concentration of wood of Maclura pomifera that is present in the mixture 14, the more likely the insect repelling device 10 will kill rather than just repel insects.

The Maclura pomifera can comprise or consist essentially of one or more insect repelling ingredient chemicals extracted from Maclura pomifera. In other words, the mixture 14 can comprise or consist essentially of one or more insect repelling ingredient chemicals extracted from Maclura pomifera. For example, the insect repelling chemical elemol can be extracted from fruit of Maclura pomifera. Elemol is available commercially from Augustus Oils Limited (Hampshire, United Kingdom) and can be synthesized in a laboratory. As another example, the insect repelling ingredient stilbene can be extracted from Maclura pomifera. One specific stilbene, 2′, 3, 4′, 5-tetrahydroxystilbene, can be extracted from Maclura pomifera via the method set forth in the article Djapic, N.; Djarmati, Z.; Filip, S.; Jankov, R. M., J. Serb. Chem. Soc. 68(3), 235-237 (2003). This stilbene is sometimes referred to as oxyresvaratrol. Oxyresveratrol is widely available commercially and can be synthesized in a laboratory. The oxyresvaratrol can then be added and made part of mixture 14. The greater concentration of insect repelling ingredient from Maclura pomifera that is present in the mixture 14, the more likely the insect repelling device 10 will kill rather than just repel insects.

The mixture 14 can further comprise wax. The wax can be one or more of the group of waxes consisting of bayberry wax, bees wax, Chinese wax, Japan wax, ozokerite, rice bran wax, and paraffin wax. The wax can be just or primarily paraffin wax. Many of these waxes are used as candle wax, and other waxes that can be used as a candle wax can be the wax used in mixture 14. The purpose of the wax is to provide a solidifying base for the Maclura pomifera component of the mixture 14, whether it be Maclura pomifera in general, the fruit of Maclura pomifera, the essential oil extract of Maclura pomifera, the wood of Maclura pomifera, or one or more insect repelling ingredient chemicals extracted from Maclura pomifera. For example, the wax can be heated until liquefied, the Maclura pomifera component can be mixed into the liquid wax, and then the liquid mixture 14 can be poured into container 12, allowed to cool and solidify.

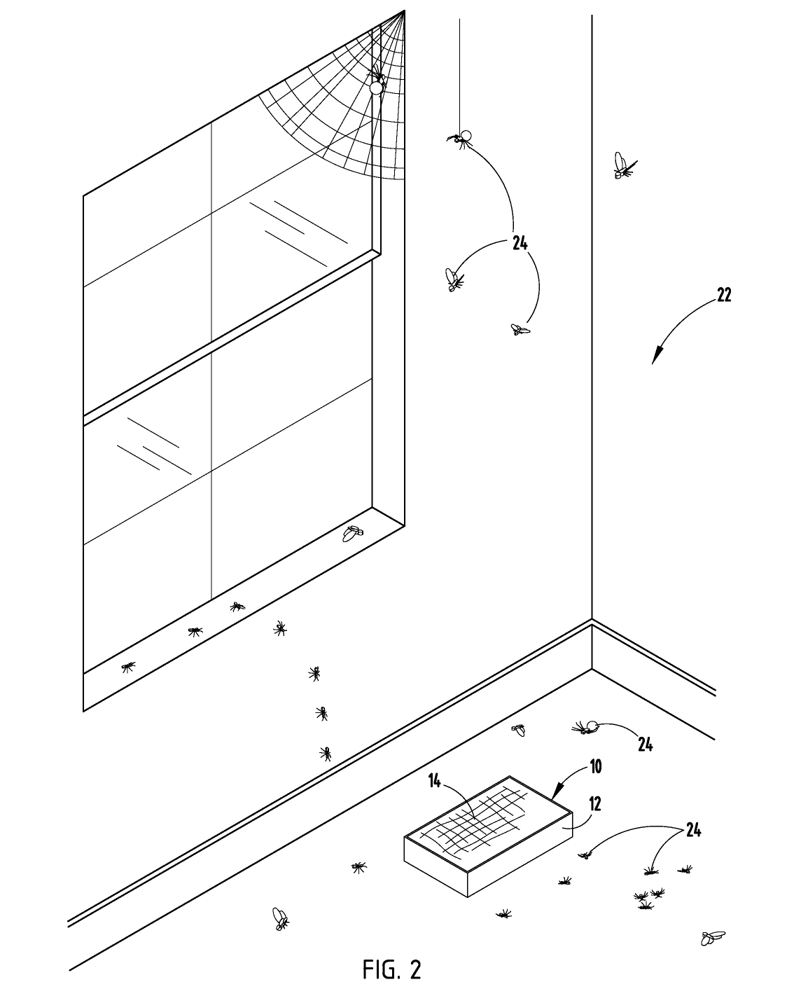

Additionally described herein is a method of repelling insects 24 (FIG. 2) in or around an area of a building 22, such as a dwelling, comprising the steps of: (a) noticing an area of a building 22 where insects 24 are present; (b) presenting an embodiment of the insect repelling device 10 described herein; and (c) placing the insect repelling device 10 in the area of the building 22. The insect repelling device 10 then repels the insects 24, or if the concentration of the Maclura pomifera is great enough, the insect repelling device 10 can kill the insects 24.

In the foregoing description, it will be readily appreciated by those skilled in the art that modifications may be made to the invention without departing from the concepts as disclosed herein. Such modifications are to be considered as included in the following claims, unless those claims by their language expressly state otherwise.

1. An insect repelling device comprising:
a container, and
a mixture comprising Maclura pomifera,
wherein the container contains the mixture.

2. The insect repelling device of claim 1, the container comprising a bottom wall and a side wall.

3. The insect repelling device of claim 2, the container further comprising a removable lid adapted to receive the side wall.

4. The insect repelling device of claim 1, the mixture further comprising wax.

5. The insect repelling device of claim 4, the wax selected from the group consisting of bayberry wax, bees wax, Chinese wax, Japan wax, ozokerite, and rice bran wax.

6. The insect repelling device of claim 4, the wax consisting essentially of paraffin wax.

7. The insect repelling device of claim 1, wherein Maclura pomifera consists essentially of the fruit of Maclura pomifera.

8. The insect repelling device of claim 1, wherein Maclura pomifera consists essentially of the essential oil extract of Maclura pomifera.

9. The insect repelling device of claim 1, wherein Maclura pomifera consists essentially of the wood of Maclura pomifera.

10. An insect repelling device comprising:
a container comprising a bottom wall, a side wall, and a removable lid adapted to receive the side wall, and
a mixture comprising wax and an insect repelling ingredient extracted from Maclura pomifera,
wherein the container contains the mixture.

11. The insect repelling device of claim 10, wherein the insect repelling ingredient extracted from Maclura pomifera comprises elemol.

12. The insect repelling device of claim 10, wherein the insect repelling ingredient extracted from Maclura pomifera comprises a stilbene.

13. The insect repelling device of claim 12, wherein the stilbene comprises 2′, 3, 4′, 5-tetrahydroxystilbene.

14. The insect repelling device of claim 11, wherein the wax comprises paraffin wax.

15. The insect repelling device of claim 12, wherein the wax comprises paraffin wax.

16. The insect repelling device of claim 13, wherein the wax comprises paraffin wax.

17. A method of repelling insects in a dwelling comprising the steps of:
noticing an area of a dwelling where insects are present;
presenting an insect repelling device comprising:
a container comprising a bottom wall, a side wall, and a removable lid adapted to
receive the side wall, and
a mixture comprising paraffin wax and an insect repelling ingredient extracted from Maclura pomifera,
wherein the container contains the mixture, and placing the insect repelling device in the area of the dwelling.

18. The method of claim 17, wherein the insect repelling ingredient extracted from Maclura pomifera comprises elemol.

19. The method of claim 17, wherein the insect repelling ingredient extracted from Maclura pomifera comprises a stilbene.

20. The insect repelling device of claim 17, wherein the stilbene comprises 2′, 3, 4′, 5-tetrahydroxystilbene.
